(19) United States
(12) Patent Application Publication
(10) Pub. No.: US 2018/0139282 A1
(43) Pub. Date: May 17, 2018

(54) MERGING OF A SINGLE USER'S IOT SENSOR DATA ACROSS MULTIPLE DEVICES DURING DOWNTIME

(71) Applicant: International Business Machines Corporation, Armonk, NY (US)

(72) Inventors: Lisa Seacat DeLuca, Baltimore, MD (US); Daniel H. Williams, Stanmore (GB)

(21) Appl. No.: 15/349,035

(22) Filed: Nov. 11, 2016

(51) Int. Cl. H04L 29/08; H04L 12/24

(52) U.S. Cl. CPC H04L 67/12; H04L 41/06

(57) ABSTRACT

Merging data from a plurality of sensors of devices during sensor outages in which the plurality of sensors are all monitoring an identical variable for a user. Over a first period of time, data values output from the plurality of sensors are recorded. When one of the plurality of sensors experiences an outage during a second period of time within the first period of time, the remaining sensors continue to monitor the variable. Missing data values during the second period of time from the sensor which experienced the outage is estimated using data values recorded from sensors functioning during that second time period and a total data value of the variable being tracked by the sensor which experienced the outage is updated.

### BACKGROUND

The present invention relates to Internet of Things (IoT) sensor data, and more specifically to merging a single user's IoT sensor data across multiple devices during downtime.

The projected number of IoT devices is expected to grow in the future. Part of the reason for this increase, beyond just technology getting smaller and cheaper, is that consumers are starting to buy multiple devices that can perform similar tasks. For example, a consumer may have a wearable device that can track step count. But, many people who have a wearable device to track steps also have a smartwatch and/or a smartphone. Both the smartphone and the smartwatch can additionally track steps. Consumers are reliant on these devices to accurately provide an accurate snapshot of what they are monitoring. However, with all of these devices, they need to be charged. If the consumer forgets to charge a device and the device runs out of charge, a gap in the analytics of what is being monitored occurs.

### SUMMARY

According to one embodiment of the present invention, a method of merging data from a plurality of sensors of devices during sensor outages, wherein the plurality of sensor monitor an identical variable is disclosed. The method comprising the steps of: a computer recording, over a first period of time, data values output from the plurality of sensors; the computer determining one of the plurality of sensors experienced an outage during a second period of time within the first period of time; the computer estimating missing data values from the sensor experiencing the outage for the second period of time using data values recorded from sensors functioning during the second period of time; and the computer updating a total data value of the variable being tracked by the sensor which experienced the outage during the second period of time.

According to another embodiment of the present invention, a computer program product for merging data from a plurality of sensors of devices during sensor outages, wherein each of the plurality of sensors of the devices monitors an identical variable is disclosed. The device each further comprising a computer comprising at least one processor, one or more memories, one or more computer readable storage media, the computer program product comprising a computer readable storage medium having program instructions embodied therewith. The program instructions executable by the computer to perform a method comprising: recording, by the computer, over a first period of time, data values output from the plurality of sensors; determining, by the computer, one of the plurality of sensors experienced an outage during a second period of time within the first period of time; estimating, by the computer, missing data values from the sensor experiencing the outage for the second period of time using data values recorded from sensors functioning during the second period of time; and updating, by the computer, a total data value of the variable being tracked by the sensor which experienced the outage during the second period of time.

According to another embodiment of the present invention, a computer system for merging data from a plurality of sensors of devices during sensor outages, wherein each of the plurality of sensors of the devices monitors an identical variable is disclosed. The computer system comprising a computer comprising at least one processor, one or more memories, one or more computer readable storage media having program instructions executable by the computer to perform the program instructions. The program instructions comprising: recording, by the computer, over a first period of time, data values output from the plurality of sensors; determining, by the computer, one of the plurality of sensors experienced an outage during a second period of time within the first period of time; estimating, by the computer, missing data values from the sensor experiencing the outage for the second period of time using data values recorded from sensors functioning during the second period of time; and updating, by the computer, a total data value of the variable being tracked by the sensor which experienced the outage during the second period of time.

### BRIEF DESCRIPTION OF THE DRAWINGS

FIG. 1 depicts an exemplary diagram of a possible data processing environment in which illustrative embodiments may be implemented.

FIG. 2 shows a flow diagram of a method of merging a single user's IoT sensor data across multiple devices during downtime.

FIGS. 3A-3C show schematics of different IoT devices implementing the method of the present invention.

FIG. 4 depicts an exemplary diagram of a possible data processing environment in which illustrative embodiments may be implemented.

### DETAILED DESCRIPTION

It should be noted that in the present application the term “downtime” refers to time during which a machine, especially a sensor of a device or the device itself with the sensor, is out of action or unavailable for use or to report or provide data regarding the variable being monitored.

While the examples in the application refer to activity monitors as the main use case, the method of the present invention may be applicable to any device with sensors which can sense variables such as flow rate, water level, temperature, power usage, etc. In this example, the wearable device would be replaced by sensors at specific points within a system with access to measuring the variable. The user may be an administrator monitoring the variable.

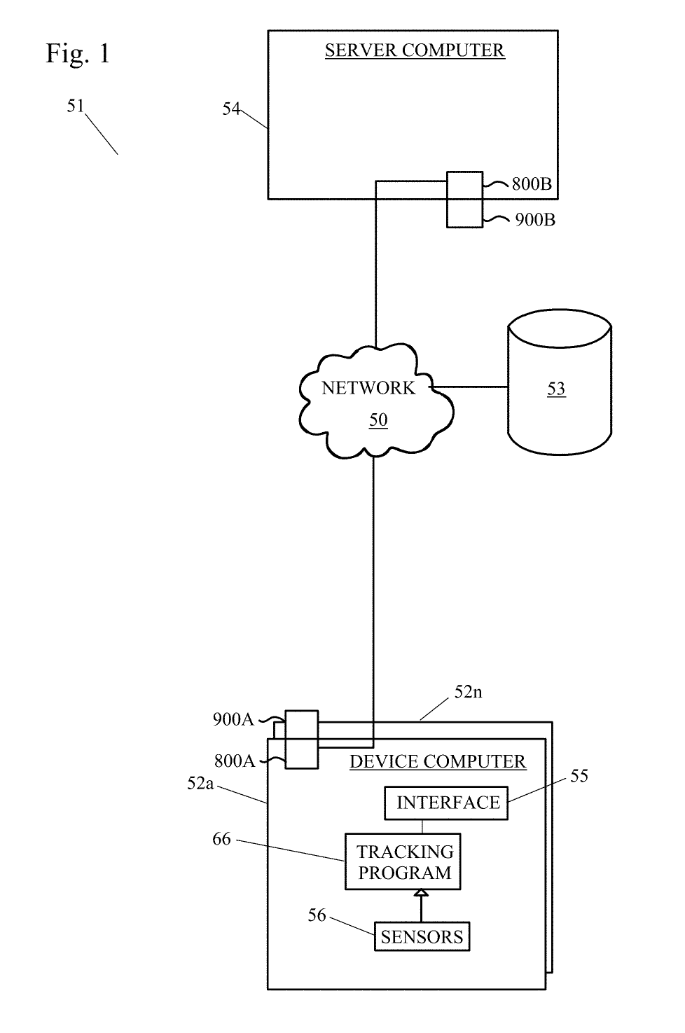

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computers 52a-52n, a repository 53, and a server computer 54 connect to network 50. In other exemplary embodiments, network data processing system 51 may include additional client or device computers, storage devices or repositories, server computers, and other devices not shown.

The device computers 52a-52n may be a plurality of different devices that are being used or are owned by a user. The device computers 52a-52n may be, but are not limited to a mobile device, a smartwatch, fitness tracker, smart glasses, smart clothing or other wearables. The device computers 52a-52n have sensors 56 for tracking or accepting data being tracked. The data being tracked may be related to activity of the user or some other variable that provides benefits from being continuously tracked.

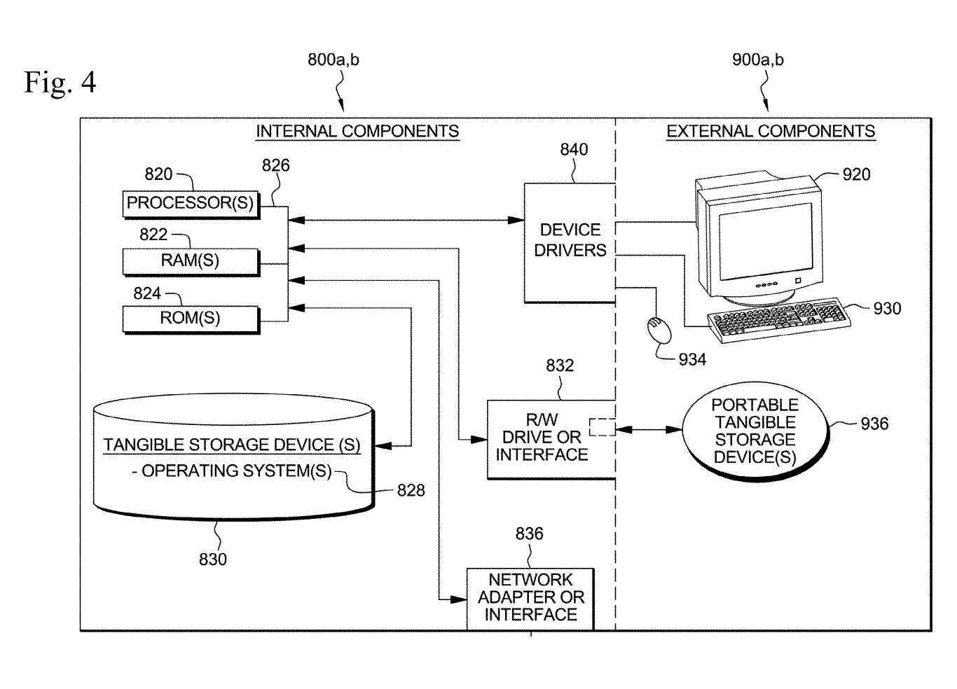

At least some of the device computers 52a-52n may contain an interface 55, which may accept commands and data entry from a user. The commands may be regarding activities being performed by the user or information regarding the variable being continuously tracked. The interface may display the variable being tracked by the user. The interface 55 can be, for example, a command line interface, a graphical user interface (GUI), a natural user interface (NUI) or a touch user interface (TUI). The device computers 52a-52n preferably include a tracking program 66. While not shown, it may be desirable to have the tracking program 66 be present on the server computer 54. The device computers 52a-52n include a set of internal components 800a and a set of external components 900a, further illustrated in FIG. 4.

Server computer 54 includes a set of internal components 800b and a set of external components 900b illustrated in FIG. 4. In the depicted example, server computer 54 provides information, such as boot files, operating system images, and applications to the device computers 52a-52n. Server computer 54 can compute the information locally or extract the information from other computers on network 50. The server computer 54 may also contain the tracking program 66.

Program code and programs such as tracking program 66 may be stored on at least one of one or more computer-readable tangible storage devices 830 shown in FIG. 4, on at least one of one or more portable computer-readable tangible storage devices 936 as shown in FIG. 4, or on storage unit 53 connected to network 50, or may be downloaded to device computers 52a-52n or server computer 54, for use. For example, program code and programs such as tracking program 66 may be stored on at least one of one or more storage devices 830 on server computer 54 and downloaded to device computers 52a-52n over network 50 for use. Alternatively, server computer 54 can be a web server, and the program code, and programs such as tracking program 66 may be stored on at least one of the one or more storage devices 830 on server computer 54 and accessed by device computers 52a-52n. In other exemplary embodiments, the program code, and programs such as tracking program 66 may be stored on at least one of one or more computer-readable storage devices 830 on device computers 52a-52n or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

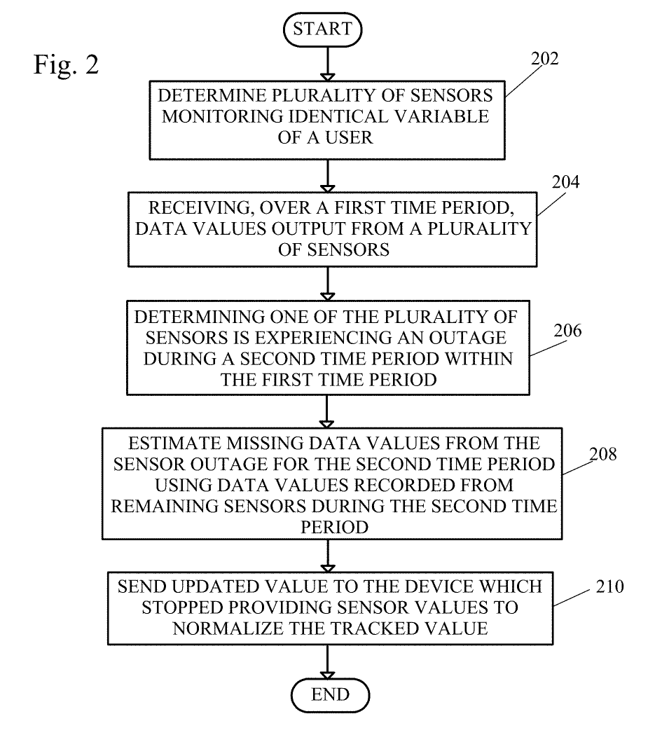

FIG. 2 shows a flow diagram of a method of merging a single user's IoT sensor data across multiple devices during downtime.

In a first step, the tracking program 66 determines a plurality of sensors of a plurality of devices monitoring an identical variable with at least some of the sensors being worn by the user (step 202). For example, the plurality of devices 52a-52n with sensors 56 may be, but are not limited to, any combination of mobile devices, smartwatches, fitness trackers, smart glasses, smart clothing and other wearables.

The tracking program 66 receives, over a first time period, data values output from the plurality of sensors of the devices (step 204). The data values may be any variable that the user wishes to track continuously for a time.

The tracking program 66 determines when one of the plurality of devices and associated sensors experiences an outage during a second period of time within the first time period (step 206). The outage may be determined if the data values fail to be received within a specific time period. It should be noted that during the outage of one of the plurality of devices and its associated sensors (temporarily nonfunctioning sensor), the remaining plurality of sensors (e.g. functioning sensors) of the plurality of devices continue to track the variable. The outage may be due to the device with the sensor losing charge, not being worn by the user, turned off or other states which prevent the device from reporting sensor values.

The tracking program 66 then estimates the missing data values from the sensor outage for the second time period using data values recorded from the remaining sensors and associated devices during the second time period (step 208).

To determine the missing data values, the tracking program 66 can calculate the difference between the data value last received from the sensor of the device which stopped reporting data and the other sensors which continued to report data values. If more than one other device and associated sensor was recording values for the same variable, the calculated difference amongst all of the devices is averaged.

The tracking program 66 then sends the updated value to the device which stopped providing sensor values to normalize the tracked value (step 210) and the method ends. In an alternate embodiment, prior to updating the value of the variable being tracked, a notification with the update value for the variable being tracked may be sent to the user to verify the modification of the tracked variable on the device which had the outage.

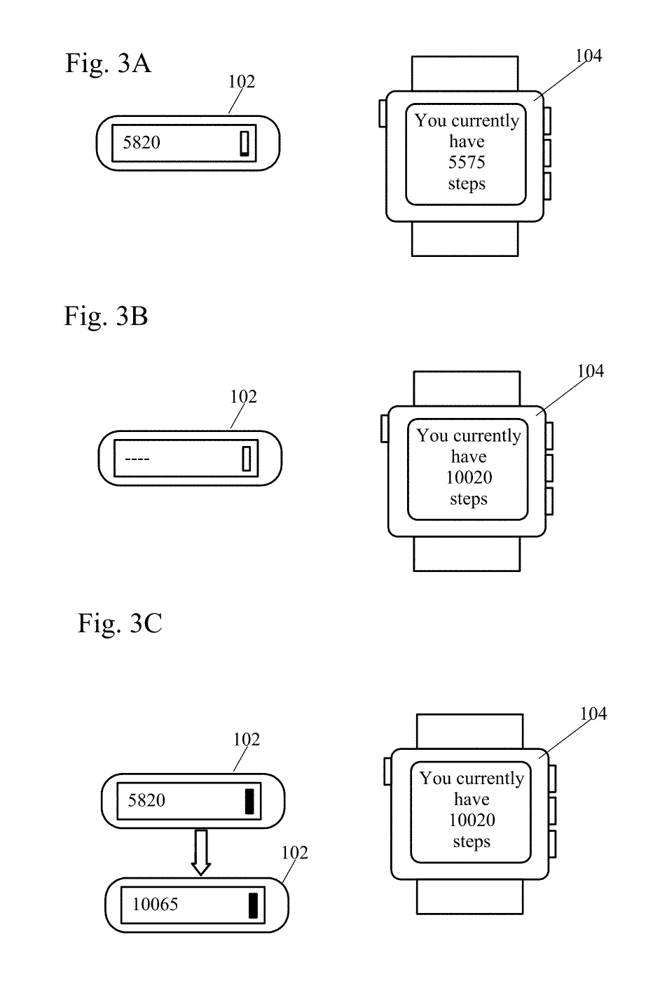

FIGS. 3A-3C shows schematics of different IoT devices implementing the method of the present invention.

A step counter 102 and a smartwatch 104 are being worn by a single user. Both the step counter 102 and the smartwatch 104 are tracking steps taken by the user through sensors such as an accelerometer, a gyroscope, etc. (not shown). Both the step counter 102 and the smartwatch 104 have to be charged at regular intervals and both devices send data input regarding the steps taken by the user to a smartphone (not shown).

FIG. 3A shows both the step counter 102 and the smartwatch 104 tracking steps taken by the user at the same time. Table 1 below shows a summary of the steps recorded and added to the device once it resumes tracking the steps.

Prior to the step counter 102 failing to track the number of steps, the step counter had 5820 steps recorded and the smartwatch had 5775 steps recorded. It should be noted that since different devices and their associated sensors measure variable differently, there is a slight discrepancy between the numbers recorded for the same variable.

The step counter 102 stops reporting the user's step information as shown in FIG. 3B, but the smartwatch 104 continues to track steps of the user while the step counter 102 is not. The step counter 102 may be charging or may have been taken off by the user. Since the step counter 102 stopped recording the user's steps, the smartwatch 104 has recorded that the user has taken a total of 4475 steps during the time period in which the step counter 102 stopped recording steps (10050 total steps for the day).

When the step counter 102 is recharged and back on the user, conventionally, the steps on the step counter 102 would be at exactly the number of steps when the device lost its charge or was taken off of the user (e.g. 5820 steps). With the method of the present invention, the tracking program 66 determines that step count difference between the step counter 102 and the smartwatch 104 which was tracking steps when the step counter 102 was not. The difference in steps is added to the step counter 102. So, the difference between 10050 steps recorded by the smartwatch 104 and 5775 steps recorded by the smartwatch 104 when the step counter 102 stopped recording steps is 4475 steps. The 4475 steps are then added to the step counter 102, changing the total on the step counter 102 to be 10295 steps.

If a third device was also tracking steps, for example a smartphone, and the smartphone had recorded a total of 5000 steps taken by the user when the step counter was no longer tracking steps, the total of 5000 and 4475 steps would be averaged, resulting in 4737.5 steps to be added to the step counter, instead of 4475 steps. The step counter 102 and the smartwatch 104 (and the smartphone) continue to track steps for the user moving forward.

TABLE 1

| | Step Counter | Smartwatch | Smartphone | |
|---|---|---|---|---|
| Steps counted | 5820 | 5575 | | |
| until step | | | | |
| counter is | | | | |
| unavailable | | | | |
| Measurement | 45 | −45 | | |
| difference | | | | |
| Additional steps | | 4475 | | |
| counted by | | | | |
| smartwatch | | | | |
| Total for | | 10050 | | |
| smartwatch | | | | |
| Difference to be | 10295 | | | |
| added to step | | | | |
| counter when | | | | |
| sensor is | | | | |
| working again | | | | |
| Additional steps | | | 5000 | |
| counted by | | | | |
| smartphone | | | | |
| Average of | | | | 4737.5 |
| smartphone and | | | | |
| smartwatch | | | | |

FIG. 4 illustrates internal and external components of device computers 52a-52n and server computer 54 in which illustrative embodiments may be implemented. In FIG. 4, device computers 52a-52n and a server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and tracking program 66 are stored on one or more of the computer-readable tangible storage devices 830 for execution by one or more of the processors 820 via one or more of the RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Tracking program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Tracking program 66 can be downloaded to device computers 52a-52n and server computer 54 from an external computer via a network (for example, the Internet, a local area network or other, wide area network) and network adapter or interface 836. From the network adapter or interface 836, tracking program 66 is loaded into hard drive 830. Tracking program 66 can be downloaded to the server computer 54 from an external computer via a network (for example, the Internet, a local area network or other, wide area network) and network adapter or interface 836. From the network adapter or interface 836, tracking program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Tracking program 66 can be written in various programming languages including low-level, high-level, object-oriented or non object-oriented languages. Alternatively, the functions of a tracking program 66 can be implemented in whole or in part by computer circuits and other hardware (not shown).

Certain embodiments of the present invention utilize the IoT data to provide more accurate results to a user improving the function of monitoring of the variable being tracked by the computer and provides analytics regarding the use of devices, allowing the software and the devices to be altered to increase efficiency to match user usage and not waste computer resources tracking the variables inaccurately.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of merging data from a plurality of sensors of devices during sensor outages, wherein the plurality of sensor monitor an identical variable, the method comprising the steps of:
a computer recording, over a first period of time, data values output from the plurality of sensors;
the computer determining one of the plurality of sensors experienced an outage during a second period of time within the first period of time;
the computer estimating missing data values from the sensor experiencing the outage for the second period of time using data values recorded from sensors functioning during the second period of time; and
the computer updating a total data value of the variable being tracked by the sensor which experienced the outage during the second period of time.

2. The method of claim 1, wherein at least some of the plurality of sensors are being worn by a user.

3. The method of claim 2, wherein the identical variable being tracked relates to a variable output by the user.

4. The method of claim 1, wherein estimation of the missing data values is calculated by the computer by taking an average of a difference in data values of all the plurality of sensors monitoring the identical variable from when the sensor began experiencing the outage and adding an averaged difference value to the sensor which experienced the outage.

5. The method of claim 4, wherein the averaged difference value is added by the computer to a tracked value of the variable being tracked when the sensor experienced the outage during the second period of time.

6. The method of claim 1, wherein the total data value of the variable being tracked by the sensor which experienced the outage during the second period of time is updated by the computer when the sensor which experienced the outage has resumed monitoring the variable and is functioning.

7. The method of claim 6, wherein prior to updating the total data value of the variable being tracked, the computer sending a notification to the user of the plurality of sensors requesting the user to verify updating the total data value for the sensor which experienced the outage during the second period of time.

8. A computer program product for merging data from a plurality of sensors of devices during sensor outages, wherein each of the plurality of sensors of the devices monitors an identical variable, the device each further comprising a computer comprising at least one processor, one or more memories, one or more computer readable storage media, the computer program product comprising a computer readable storage medium having program instructions embodied therewith, the program instructions executable by the computer to perform a method comprising:
recording, by the computer, over a first period of time, data values output from the plurality of sensors;
determining, by the computer, one of the plurality of sensors experienced an outage during a second period of time within the first period of time;
estimating, by the computer, missing data values from the sensor experiencing the outage for the second period of time using data values recorded from sensors functioning during the second period of time; and
updating, by the computer, a total data value of the variable being tracked by the sensor which experienced the outage during the second period of time.

9. The computer program product of claim 8, wherein at least some of the plurality of sensors are being worn by a user.

10. The computer program product of claim 9, wherein the identical variable being tracked relates to a variable output by the user.

11. The computer program product of claim 8, wherein estimation of the missing data values is calculated, by the computer, by taking an average of a difference in data values of all the plurality of sensors monitoring the identical variable from when the sensor began experiencing the outage and adding an averaged difference value to the sensor which experienced the outage.

12. The computer program product of claim 11, wherein the averaged difference value is added to a tracked value of the variable being tracked when the sensor experienced the outage during the second period of time.

13. The computer program product of claim 8, wherein the total data value of the variable being tracked by the sensor which experienced the outage during the second period of time is updated, by the computer, when the sensor which experienced the outage has resumed monitoring the variable and is functioning.

14. The computer program product of claim 13, wherein prior to updating the total data value of the variable being tracked, sending, by the computer, a notification to the user of the plurality of sensors requesting the user to verify updating the total data value for the sensor which experienced the outage during the second period of time.

15. A computer system for merging data from a plurality of sensors of devices during sensor outages, wherein each of the plurality of sensors of the devices monitors an identical variable, the computer system comprising a computer comprising at least one processor, one or more memories, one or more computer readable storage media having program instructions executable by the computer to perform the program instructions comprising:
recording, by the computer, over a first period of time, data values output from the plurality of sensors;
determining, by the computer, one of the plurality of sensors experienced an outage during a second period of time within the first period of time;
estimating, by the computer, missing data values from the sensor experiencing the outage for the second period of time using data values recorded from sensors functioning during the second period of time; and
updating, by the computer, a total data value of the variable being tracked by the sensor which experienced the outage during the second period of time.

16. The computer program product of claim 15, wherein at least some of the plurality of sensors are being worn by a user.

17. The computer program product of claim 16, wherein the identical variable being tracked relates to a variable output by the user.

18. The computer program product of claim 15, wherein estimation of the missing data values is calculated, by the computer, by taking an average of a difference in data values of all the plurality of sensors monitoring the identical variable from when the sensor began experiencing the outage and adding an averaged difference value to the sensor which experienced the outage.

19. The computer program product of claim 18, wherein the averaged difference value is added to a tracked value of the variable being tracked when the sensor experienced the outage during the second period of time.

20. The computer program product of claim 15, wherein the total data value of the variable being tracked by the sensor which experienced the outage during the second period of time is updated, by the computer, when the sensor which experienced the outage has resumed monitoring the variable and is functioning.
